(19) United States
(12) Patent Application Publication
(10) Pub. No.: US 2018/0148547 A1
(43) Pub. Date: May 31, 2018

(54) METHOD FOR PRODUCING RUBBER COMPOSITION

(71) Applicant: TOYO TIRE & RUBBER CO., LTD., Itami-shi (JP)

(72) Inventor: Souichiro Miura, Itami-shi (JP)

(73) Assignee: TOYO TIRE & RUBBER CO., LTD., Itami-shi (JP)

(21) Appl. No.: 15/791,629

(22) Filed: Oct. 24, 2017

(30) Foreign Application Priority Data
Nov. 29, 2016 (JP) 2016-231021

(51) Int. Cl. C08J 3/00; C08L 9/06

(52) U.S. Cl. CPC C08J 3/005; C08L 9/06; C08L 2207/04; C08J 2425/04; C08J 2309/06

(57) ABSTRACT

There is provided a method for producing a rubber composition from which a vulcanized rubber having excellent wet gripping performance, rubber hardness and abrasion resistance is yielded. This method is a method for producing a rubber composition including a diene rubber, one or more resins, and a styrene based thermoplastic elastomer. The resin(s) is/are one or more out of nonaromatic terpene resins and aliphatic petroleum resins. The method includes the step of mixing the resin(s) with the styrene based thermoplastic elastomer to produce a kneaded product, and the step of mixing the resultant kneaded product with the diene rubber.

### BACKGROUND OF THE INVENTION

### Field of the Invention

The present invention relates to a method for producing a rubber composition.

### Description of the Related Art

As a rubber composition for tires that contains a diene rubber, various rubber compositions have been disclosed to improve the tires in various performances such as steering stability, gripping performance, wet gripping performance, and abrasion resistance.

For example, Patent Documents 1 and 2 disclose tire tread rubber compositions each including a diene rubber, an elastomer obtained by hydrogenating a styrene-diene-styrene copolymer partially, an aromatic modified terpene resin, and others.

The documents state that the elastomer, which is obtained by hydrogenating a styrene-diene-styrene copolymer partially, can improve the rubber composition for tires in wet performance, high-temperature-state rubber hardness, elastic modulus, and rubber strength, so that the composition can improve the tires in performance such as steering stability. The documents also state that the aromatic modified terpene resin is good in compatibility with diene rubbers to succeed in improving wet performance in the composition for tires.

As a composition including a terpene resin, known is a rubber composition for tires described in Patent Document 3, or an adhesive agent composition for rolled multilayered-tire-inner products described in Patent Document 4.

### PRIOR ART DOCUMENTS

### Patent Documents

Patent Document 1: JP-A-2014-189697

Patent Document 2: JP-A-2014-189698

Patent Document 3: Japanese Patent No. 5815708

Patent Document 4: JP-A-2015-502882

In the market, a pneumatic tire made by using a rubber composition has been required to be better in wet gripping performance, rubber hardness, and abrasion resistance. However, pneumatic tires yielded, respectively, from rubber compositions as described in Patent Documents 1 to 3, or other vulcanized rubbers do not satisfy these properties.

### SUMMARY OF THE INVENTION

In the light of the above-mentioned actual situation, the present invention has been made. An object thereof is to provide a method for producing a rubber composition from which a vulcanized rubber having excellent wet gripping performance, rubber hardness and abrasion resistance is yielded.

The present invention relates to a method for producing a rubber composition including a diene rubber, one or more resins, and a styrene based thermoplastic elastomer, the resin(s) being one or more out of nonaromatic terpene resins and aliphatic petroleum resins, and the method including the step of mixing the resin(s) with the styrene based thermoplastic elastomer to produce a kneaded product, and the step of mixing the resultant kneaded product with the diene rubber.

Details of an effect mechanism of advantageous effects of the method for producing rubber composition according to the present invention are partially unclear; however, it is presumed that the mechanism is as described below. However, the present invention may not be interpreted to be limited to this effect mechanism.

The rubber composition producing method of the present invention is a method for producing a rubber composition including a diene rubber, one or more resins out of nonaromatic terpene resins and aliphatic petroleum resins, and a styrene based thermoplastic elastomer, and includes the step of mixing the resin(s) with the styrene based thermoplastic elastomer to produce a kneaded product, and the step of mixing the resultant kneaded product with the diene rubber. It is presumed that the resin(s) is/are partially compatible with the styrene based thermoplastic elastomer (i.e., compatible with its/their soft segments, which are not segments of styrene), and thus only a low glass transition temperature of the styrene based thermoplastic elastomer in the kneaded product is shifted to about 0° C. so that the resultant vulcanized rubber is improved in wet gripping performance, rubber hardness and abrasion resistance.

It is also presumed that one or more rubber components of the diene rubber are incompatible with the styrene based thermoplastic elastomer so that the glass transition temperature of the rubber component(s) is not changed.

It is also presumed that in the case of using, as the resin(s), a resin including an aromatic compound, this aromatic-compound-including resin is completely compatible with the styrene based thermoplastic elastomer so that the advantageous effects of the present invention are not easily produced.

### DETAILED DESCRIPTION OF THE PREFERRED EMBODIMENTS

### <Rubber Composition Producing Method>

The rubber composition producing method of the present invention method is a method for producing a rubber composition including a diene rubber, one or more resins, and a styrene based thermoplastic elastomer, and the resin(s) is/are one or more out of nonaromatic terpene resins and aliphatic petroleum resins. The method includes the step of mixing the resin(s) with the styrene based thermoplastic elastomer to produce a kneaded product (hereinafter, this step may be referred to as the first step), and the step of mixing the resultant kneaded product with the diene rubber (hereinafter, this step may be referred to as the second step).

Examples of the diene rubber include natural rubber (NR); and synthetic diene rubbers such as isoprene rubber (IR), styrene-butadiene rubber (SBR), butadiene rubber (BR), butyl rubber (IIR), acrylonitrile-butadiene rubber (NBR), and chloroprene rubber. Such diene rubbers may be used singly or in any combination of two or more thereof.

The resin(s) is/are one or more out of nonaromatic terpene resins and aliphatic petroleum resins, which each include in the molecule thereof no aromatic compound. The resin may be used singly, or the resins may be used in any combination of two or more thereof.

Examples of the nonaromatic terpene resins include terpene based resins such as α-pinene polymers, β-pinene polymers, and dipentene polymers; and modified terpene resins (for example, hydrogenated terpene resin, hydrocarbon-modified terpene resin, and the like) obtained by subjecting these terpene based resins, respectively, to a modification (such as hydrogenating modification or hydrocarbon modification).

Examples of the aliphatic petroleum resins include resins each obtained by cation-polymerizing an unsaturated monomer, such as isoprene or cyclopentadiene, which is a petroleum distillate corresponding to a compound having 4 or 5 carbon atoms (C5 distillate) (the resins may be also referred to C5 type petroleum resins); and resins obtained by hydrogenating the C5 type petroleum resins, respectively.

The softening point of the resin(s) is preferably 50° C. or higher, more preferably 70° C. or higher, and is preferably 180° C. or lower, more preferably 160° C. or lower. The softening point is measured in accordance with the ring and ball method described in JIS K2207.

The styrene based thermoplastic elastomer is a copolymer configured to have polystyrene blocks, and elastomer blocks each having a polyolefin structure. Examples thereof include styrene-butadiene-styrene block copolymer (SBS), styrene-isoprene-styrene block copolymer (SIS), styrene-ethylene/butylene-styrene block copolymer (SEBS), and styrene-ethylene/propylene-styrene block copolymer (SEPS); and resins obtained by hydrogenating these copolymers, respectively (hydrogenated styrene based thermoplastic elastomers). Out of these resins, SEBS and SEPS are preferred from the viewpoint of the compatibility thereof with the resin(s). Such styrene based thermoplastic elastomers may be used singly or in any combination of two or more thereof.

About the styrene based thermoplastic elastomer, the glass transition temperature thereof is from −70 to 0° C., more preferably from −60 to −5° C., even more preferably from −50 to −10° C. from the viewpoint of an improvement of the rubber composition in wet performance.

### <First Step>

The first step in the present invention is a step of mixing the resin(s) with the styrene based thermoplastic elastomer to produce a kneaded product.

In the first step, the amount of the resin(s) is preferably from 20 to 200 parts by weight, more preferably from 30 to 150 parts by weight, even more preferably from 40 to 120 parts by weight for 100 parts by weight of the styrene based thermoplastic elastomer from the viewpoint of an improvement of the rubber composition in various physical properties (wet gripping performance, rubber hardness and abrasion resistance).

In the first step, the method for mixing the resin(s) with the styrene based thermoplastic elastomer is not particularly limited, and is usually preferably a dry mixing method. The dry mixing method may be, for example, a method of mixing/kneading these components, using a kneading machine used in an ordinary rubber industry, such as a Banbury mixer, a kneader or a roll. The number of times of the mixing/kneading may one or more. The period for the mixing/kneading may be varied in accordance with, for example, the size of a kneading machine to be used. The period may be usually from about 2 to 5 minutes. The discharge temperature of the kneading machine is preferably from 120 to 170° C., more preferably from 120 to 150° C.

### <Second Step>

The second step in the present invention is a step of mixing the kneaded product yielded as described above with the diene rubber.

In the second step, the amount of the kneaded product is preferably from 2 to 50 parts by weight, more preferably from 4 to 40 parts by weight, even more preferably from 8 to 30 parts by weight for 100 parts by weight of the diene rubber (the rubber component contained in the rubber composition) from the viewpoint of an improvement of the rubber composition in various physical properties.

In the second step, the amount of the resin(s) included in the kneaded product is preferably from 1 to 25 parts by weight, more preferably from 2 to 20 parts by weight, even more preferably from 4 to 15 parts by weight for 100 parts by weight of the diene rubber (the rubber component contained in the rubber composition).

In the second step, the amount of the styrene based thermoplastic elastomer included in the kneaded product is preferably from 1 to 25 parts by weight, more preferably from 2 to 20 parts by weight, even more preferably from 4 to 15 parts by weight for 100 parts by weight of the diene rubber (the rubber component contained in the rubber composition).

In the second step, the method for mixing the kneaded product with the diene rubber is not particularly limited, and is usually preferably a dry mixing method. The dry mixing method may be, for example, a method of mixing/kneading these materials, using a kneading machine used in an ordinary rubber industry, such as a Banbury mixer, a kneader or a roll. The number of times of the mixing/kneading may be one or more. The period for the mixing/kneading may be varied in accordance with, for example, the size of a kneading machine to be used. The period may be usually from about 2 to 5 minutes. The discharge temperature of the kneading machine is preferably from 120 to 170° C., more preferably from 120 to 150° C. When the rubber composition contains a sulfur-containing vulcanizer, a vulcanization accelerator, and other vulcanization-related components that will be detailed later, the discharge temperature of the kneading machine is preferably from 80 to 110° C., more preferably from 80 to 100° C.

### <Various Blending Agents>

In the rubber composition producing method (the first and/or the second step(s)) of the present invention, various blending agents are further usable. Examples of the usable blending agents include a sulfur-containing vulcanizer (in the second step), a vulcanization accelerator (in the second step), an antiaging agent (in the first and/or second step(s)), carbon black (in the first and/or second step(s)), silica (in the second step), a silane coupling agent (in the second step), zinc oxide (in the first and/or second step(s)), a methylene receptor and a methylene donor (in the first and/or second step(s)), stearic acid (in the first and/or second step(s)), a vulcanization accelerator aid (in the second step), a vulcanization retardant (in the second step), an organic peroxide (in the second step), softeners such as wax and oil (in the second step), a processing aid (in the first and/or second step(s)), and other blending agents used ordinarily in the rubber industry.

The species of sulfur in the sulfur-containing vulcanizer may be any ordinary sulfur species for rubbers. Examples thereof include powdery sulfur, precipitated sulfur, insoluble sulfur, and highly dispersible sulfur. Such sulfur-containing vulcanizers may be used singly or in any combination of two or more thereof.

The sulfur content in the rubber composition according to the present invention is preferably from 0.3 to 6.5 parts by weight for 100 parts by weight of the diene rubber (the rubber component contained in the rubber composition). If the sulfur content is less than 0.3 parts by weight, the vulcanized rubber is short in cross linkage density to be lowered in rubber strength and others. If the content is more than 6.5 parts by weight, the vulcanized rubber is deteriorated, particularly, in both of heat resistance and durability. In order to keep the rubber strength of the vulcanized rubber good certainly and improve the heat resistance and the durability further, the sulfur content is more preferably set into the range of 1.0 to 5.5 parts by weight for 100 parts by weight of the diene rubber.

The vulcanization accelerator may be an ordinary vulcanization accelerator for rubbers. Examples thereof include sulfenamide type, thiuram type, thiazole type, thiourea type, guanidine type, and dithiocarbamate type vulcanization accelerators. Such vulcanization accelerators may be used singly or in any combination of two or more thereof.

The vulcanization accelerator content is preferably from 1 to 5 parts by weight for 100 parts by weight of the diene rubber (the rubber component contained in the rubber composition).

The antiaging agent may be an ordinary antiaging agent for rubbers, examples thereof including aromatic amine type, amine-ketone type, monophenolic type, bisphenolic type, polyphenolic type, dithiocarbamate type, and thiourea type antiaging agents. Such antiaging agents may be used singly or in any combination of two or more thereof.

The antiaging agent content is preferably from 1 to 5 parts by weight for 100 parts by weight of the diene rubber (the rubber component contained in the rubber composition).

The species of the carbon black is not particularly limited, and may be any carbon black species used in an ordinary rubber industry, such as SAF, ISAF, HAF, FEF or GPF, or may be a conductive carbon black species such as acetylene black or ketjen black. The form of the carbon black species may be a granulated carbon black species, which has been granulated, considering the handleability thereof in an ordinary rubber industry; or may be a non-granulated carbon black species. Such carbon black species may be used singly or in any combination of two or more thereof.

The carbon black content is preferably from 5 to 50 parts by weight, more preferably form 10 to 30 parts by weight for 100 parts by weight of the diene rubber (the rubber component contained in the rubber composition).

The species of the silica is not limited, and may be any species as far as the species is usable as a filler for reinforcement. The species preferably may be wet silica (hydrous silicate). Colloidal properties of the silica are not particularly limited. The nitrogen adsorption specific surface area (BET) thereof is preferably from 150 to 250 m²/g, more preferably from 180 to 230 m²/g, the BET being according to the BET method. The BET of the silica is measured in accordance with the BET method described in ISO 5794. Such silica species may be used singly or in any combination of two or more thereof.

The silica content is preferably from 40 to 100 parts by weight, more preferably from 50 to 80 parts by weight for 100 parts by weight of the diene rubber (the rubber component contained in the rubber composition).

The silane coupling agent may be an ordinary silane coupling agent for rubbers. Examples thereof include sulfide silanes such as bis(3-triethoxysilylpropyl) tetrasulfide, bis(3-triethoxysilylpropyl) disulfide, bis(2-triethoxysilylethyl) tetrasulfide, bis(4-triethoxysilylbutyl) disulfide, bis(3-trimethoxysilylpropyl) tetrasulfide, and bis(2-trimethoxysilylethyl) disulfide; mercaptosilanes such as 3-mercaptopropyltrimethoxysilane, 3-mercaptopropyltriethoxysilane, 3-mercaptopropylmethyldimethoxysilane, 3-mercaptopropyldimethylmethoxysilane, and mercaptoethyltriethylsilane; and protected mercaptosilanes such as 3-octanoylthio-1-propyltriethoxysilane, and 3-propionylthiopropyltrimethoxysilane. Such silane coupling agents may be used singly or in any combination of two or more thereof.

The silane coupling agent content is preferably 2% by weight or more, more preferably 4% by weight or more of by weight of silica, and is preferably 20% by weight or less, more preferably 15% by weight or less thereof to cause the advantageous effect based on the addition of the agent to be sufficiently exhibited.

In the blending (addition) of the various blending agents, the method for the blending is not particularly limited, and may be, for example, a method of adding components other than the sulfur-based components such as the sulfur-containing vulcanizer and the vulcanization accelerator in any order, and mixing/kneading the components, a method of adding the components simultaneously and mixing/kneading the components; or a method of adding the entire components simultaneously and mixing/kneading the components.

A vulcanized rubber yielded from the rubber composition of the present invention has good wet gripping performance, rubber hardness and abrasion resistance to be suitable for a pneumatic tire.

### EXAMPLES

Hereinafter, the present invention will be described by way of examples thereof. However, the present invention is not limited by the examples.

### <Used Materials>

a) Nonaromatic terpene resin: “YS RESIN PX1250” (manufactured by Yasuhara Chemical Co., Ltd.; softening point: 125° C.)

b) Aliphatic resin: “QUINTONE M100” (manufactured by Zeon Corporation; 95° C.)

c) Aromatic terpene resin: “YS RESIN TO125” (manufactured by Yasuhara Chemical Co., Ltd.; softening point: 125° C.)

d) Styrene based thermoplastic elastomers:
Styrene based thermoplastic elastomer (1): “SEPTON S063” (SEPS, manufactured by Kuraray Co., Ltd.; glass transition temperature: −50° C.)
Styrene based thermoplastic elastomer (2): “S.O.E.S 1606” (SEBS, manufactured by Asahi Kasei Corporation; glass transition temperature: −13° C.);

e) Styrene-butadiene rubber (SBR): “SBR 1502” (manufactured by JSR Corporation)

f) Silica: “NIPSIL AQ” (manufactured by Tosoh Silica Corporation; BET: 205 m²/g)

g) Carbon black: “SEAST KH” (manufactured by Tokai Carbon Co., Ltd.)

h) Si lane coupling agent: “Si 75” (manufactured by Evonik Degussa GmbH)

i) Zinc flower: “Zinc flower No. 1” (manufactured by Mitsui Mining & Smelting Co., Ltd.)

j) Antiaging agent: “NOCRAC 6C” (manufactured by Ouchi Shinko Chemical Industrial Co., Ltd.)

k) Stearic acid: “LUNAC S-20” (manufactured by Kao Corporation);

l) Wax: “OZOACE 0355” (manufactured by Nippon Seiro Co., Ltd.);

m) Sulfur: “5%-Oil-blended powdery sulfur” (manufactured by Tsurumi Chemical Industry Co., Ltd.); and

n) Vulcanization accelerator: “SOXINOL CZ” (manufactured by Sumitomo Chemical Co., Ltd.).

### Example 1

### <Production of Kneaded Product>

A biaxial roll was used to dry-mix a nonaromatic terpene resin and a styrene based thermoplastic elastomer in the first step described in Table 1 with each other (mixing/kneading period: 3 minutes, and discharge temperature: 120° C.) to produce a kneaded product.

### <Production of Rubber Composition>

Next, a Banbury mixer was used to dry-mix individual materials (other than sulfur and a vulcanization accelerator) in the second step described in Table 1 with each other (mixing/kneading period: 3 minutes, and discharge temperature: 150° C.) to produce a rubber composition. Next, the sulfur and the vulcanization accelerator in described in Table 1 were added to the resultant rubber composition, and then the Banbury mixer was used to dry-mix these materials with each other (mixing/kneading period: 1 minute, and discharge temperature: 90° C.) to produce an unvulcanized rubber composition. In Table 1, each blend amount is represented in the unit of parts by weight (phr) relative to the amount of the rubber component of the diene rubber, this amount being regarded as 100 parts by weight.

### Examples 2 to 12

In each of the examples, a kneaded product and an unvulcanized rubber composition were produced in the same way as in Example 1 except that one or more of the following were changed as shown in Table 1: the respective species of the individual materials; and the respective blend amounts thereof.

### Comparative Examples 1 to 11

In each of the examples, a Banbury mixer was used to dry-mix individual materials including a nonaromatic terpene resin and a styrene based thermoplastic elastomer (other than sulfur and a vulcanization accelerator) in the second step described in Table 2 with each other (mixing/kneading period: 3 minutes, and discharge temperature: 150° C.) to produce a rubber composition. Next, the sulfur and the vulcanization accelerator in described in Table 1 were added to the resultant rubber composition, and then the Banbury mixer was used to dry-mix these materials with each other (mixing/kneading period: 1 minute, and discharge temperature: 90° C.) to produce an unvulcanized rubber composition.

### Comparative Example 12

A kneaded product and an unvulcanized rubber composition were produced in the same way as in Example 1 except that some of the following were changed as shown in Table 2: the respective species of the individual materials; and the respective blend amounts thereof.

The unvulcanized rubber composition yielded in each of the examples and the comparative examples was vulcanized at 150° C. for 30 minutes to produce a vulcanized rubber. The resultant vulcanized rubber was evaluated as described below. The evaluation results are shown in Tables 1 and 2.

### <Wet Gripping Performance Evaluation>

About the evaluation of the wet gripping performance of the resultant vulcanized rubber, a rheospectrometer E4000 manufactured by UBM was used to measure the loss tangent tan δ (tan δ at 0° C.) of a test piece of this rubber under conditions of a frequency of 10 Hz, a static strain of 10%, a dynamic strain of 2% and a temperature of 0° C. The measured value is represented as an index relative to the value of Comparative Example 1, this value being regarded as 100. The tan δ at 0° C. is generally used as an index of gripping performance onto a wet road surface. It is demonstrated that as the index is larger to be larger in tan δ, the wet gripping performance is better.

### <Rubber Hardness Evaluation>

About the evaluation of the rubber hardness of the resultant vulcanized rubber, a durometer, type A was used to measure the hardness of a test piece of this rubber at 23° C. in accordance with JIS K6253. The measured value is represented as an index relative to the value of Comparative Example 1 which was regarded as 100. It is demonstrated that as the index is larger to be higher in hardness at ambient temperature, the rubber hardness is better.

### <Abrasion Resistance Evaluation>

About the evaluation of the abrasion resistance of the resultant vulcanized rubber, a Lambourn abrasion tester manufactured by Iwamoto Seisakusho Co., Ltd. was used to measure the abrasion loss of a test piece of this rubber at a load of 40N, a slip ratio of 30%, a temperature of 23° C. and a sand-dropping rate of 20 g/minute in accordance with JIS K6264. The inverse number of the abrasion loss is represented as an index relative to the value of Comparative Example 1, this value being regarded as 100. It is demonstrated that as the index is larger to be smaller in abrasion loss, the abrasion resistance is better.

TABLE 1

| | | | Example | Example | Example | Example | Example | Example |
|---|---|---|---|---|---|---|---|---|
| | | | 1 | 2 | 3 | 4 | 5 | 6 |
| Rubber | First | Nonaromatic terpene resin | 5 | 5 | 10 | | | |
| composition | step | Aliphatic resin | | | | 5 | 5 | 10 |
| production | | Aromatic terpene resin | | | | | | |
| | | Styrene based thermoplastic | 5 | 10 | 10 | 5 | 10 | 10 |
| | | elastomer (1) | | | | | | |
| | | Styrene based thermoplastic | | | | | | |
| | | elastomer (2) | | | | | | |
| | Second | ESBR | 100 | 100 | 100 | 100 | 100 | 100 |
| | step | Silica | 60 | 60 | 60 | 60 | 60 | 60 |
| | | Carbon black | 20 | 20 | 20 | 20 | 20 | 20 |
| | | Silane coupling agent | 5 | 5 | 5 | 5 | 5 | 5 |
| | | Zinc flower | 3 | 3 | 3 | 3 | 3 | 3 |
| | | Antiaging agent | 2 | 2 | 2 | 2 | 2 | 2 |
| | | Stearic acid | 2 | 2 | 2 | 2 | 2 | 2 |
| | | Wax | 2 | 2 | 2 | 2 | 2 | 2 |
| | | Sulfur | 2 | 2 | 2 | 2 | 2 | 2 |
| | | Vulcanization accelerator | 2 | 2 | 2 | 2 | 2 | 2 |
| Evaluations | | Wet gripping performance | 106 | 107 | 110 | 110 | 111 | 112 |
| | | Rubber hardness | 102 | 103 | 102 | 102 | 102 | 102 |
| | | Abrasion resistance | 106 | 106 | 108 | 108 | 108 | 109 |
| | | | Example | Example | Example | Example | Example | Example |
| | | | 7 | 8 | 9 | 10 | 11 | 12 |
| Rubber | First | Nonaromatic terpene resin | 5 | 5 | 10 | | | |
| composition | step | Aliphatic resin | | | | 5 | 5 | 10 |
| production | | Aromatic terpene resin | | | | | | |
| | | Styrene based thermoplastic | | | | | | |
| | | elastomer (1) | | | | | | |
| | | Styrene based thermoplastic | 5 | 10 | 10 | 5 | 10 | 10 |
| | | elastomer (2) | | | | | | |
| | Second | ESBR | 100 | 100 | 100 | 100 | 100 | 100 |
| | step | Silica | 60 | 60 | 60 | 60 | 60 | 60 |
| | | Carbon black | 20 | 20 | 20 | 20 | 20 | 20 |
| | | Silane coupling agent | 5 | 5 | 5 | 5 | 5 | 5 |
| | | Zinc flower | 3 | 3 | 3 | 3 | 3 | 3 |
| | | Antiaging agent | 2 | 2 | 2 | 2 | 2 | 2 |
| | | Stearic acid | 2 | 2 | 2 | 2 | 2 | 2 |
| | | Wax | 2 | 2 | 2 | 2 | 2 | 2 |
| | | Sulfur | 2 | 2 | 2 | 2 | 2 | 2 |
| | | Vulcanization accelerator | 2 | 2 | 2 | 2 | 2 | 2 |

| | | | | | | | |
|---|---|---|---|---|---|---|---|
| Evaluations | Wet gripping performance | 109 | 110 | 108 | 110 | 111 | 109 |
| | Rubber hardness | 103 | 103 | 105 | 102 | 102 | 104 |
| | Abrasion resistance | 106 | 105 | 106 | 107 | 107 | 109 |

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Rubber | First step | Nonaromatic terpene resin | | | | | | |
| composition | | Aliphatic resin | | | | | | |
| production | | Aromatic terpene resin | | | | | | |
| | | Styrene based thermoplastic | | | | | | |
| | | elastomer (1) | | | | | | |
| | | Styrene based thermoplastic | | | | | | |
| | | elastomer (2) | | | | | | |
| | Second step | ESBR | 100 | 100 | 100 | 100 | 100 | 100 |
| | | Silica | 60 | 60 | 60 | 60 | 60 | 60 |
| | | Carbon black | 20 | 20 | 20 | 20 | 20 | 20 |
| | | Silane coupling agent | 5 | 5 | 5 | 5 | 5 | 5 |
| | | Zinc flower | 3 | 3 | 3 | 3 | 3 | 3 |
| | | Antiaging agent | 2 | 2 | 2 | 2 | 2 | 2 |
| | | Stearic acid | 2 | 2 | 2 | 2 | 2 | 2 |
| | | Wax | 2 | 2 | 2 | 2 | 2 | 2 |
| | | Nonaromatic terpene resin | | | | | 10 | |
| | | Aliphatic resin | | | | | | 10 |
| | | Aromatic terpene resin | | | | 10 | | |
| | | Styrene based thermoplastic | | 10 | | | | |
| | | elastomer (1) | | | | | | |
| | | Styrene based thermoplastic | | | 10 | | | |
| | | elastomer (2) | | | | | | |
| | | Sulfur | 2 | 2 | 2 | 2 | 2 | 2 |
| | | Vulcanization accelerator | 2 | 2 | 2 | 2 | 2 | 2 |

| | | | | | | | |
|---|---|---|---|---|---|---|---|
| Evaluations | Wet gripping performance | 100 | 101 | 102 | 104 | 102 | 106 |
| | Rubber hardness | 100 | 101 | 101 | 100 | 99 | 95 |
| | Abrasion resistance | 100 | 100 | 100 | 104 | 102 | 104 |

| | | | Comparative | Comparative | Comparative | Comparative | Comparative | Comparative |
|---|---|---|---|---|---|---|---|---|
| | | | Example 7 | Example 8 | Example 9 | Example 10 | Example 11 | Example 12 |
| Rubber | First step | Nonaromatic terpene resin | | | | | | |
| composition | | Aliphatic resin | | | | | | |
| production | | Aromatic terpene resin | | | | | | 10 |
| | | Styrene based thermoplastic | | | | | | 10 |
| | | elastomer (1) | | | | | | |
| | | Styrene based thermoplastic | | | | | | |
| | | elastomer (2) | | | | | | |
| | Second step | ESBR | 100 | 100 | 100 | 100 | 100 | 100 |
| | | Silica | 60 | 60 | 60 | 60 | 60 | 60 |
| | | Carbon black | 20 | 20 | 20 | 20 | 20 | 20 |
| | | Silane coupling agent | 5 | 5 | 5 | 5 | 5 | 5 |
| | | Zinc flower | 3 | 3 | 3 | 3 | 3 | 3 |
| | | Antiaging agent | 2 | 2 | 2 | 2 | 2 | 2 |
| | | Stearic acid | 2 | 2 | 2 | 2 | 2 | 2 |
| | | Wax | 2 | 2 | 2 | 2 | 2 | 2 |
| | | Nonaromatic terpene resin | | 10 | | 10 | | |
| | | Aliphatic resin | | | 10 | | 10 | |
| | | Aromatic terpene resin | 10 | | | | | |
| | | Styrene based thermoplastic | 10 | 10 | 10 | | | |
| | | elastomer (1) | | | | | | |
| | | Styrene based thermoplastic | | | | 10 | 10 | |
| | | elastomer (2) | | | | | | |
| | | Sulfur | 2 | 2 | 2 | 2 | 2 | 2 |
| | | Vulcanization accelerator | 2 | 2 | 2 | 2 | 2 | 2 |

| | | | | | | | |
|---|---|---|---|---|---|---|---|
| Evaluations | Wet gripping performance | 104 | 103 | 102 | 103 | 102 | 103 |
| | Rubber hardness | 100 | 99 | 97 | 99 | 98 | 100 |
| | Abrasion resistance | 105 | 100 | 103 | 104 | 104 | 102 |

What is claimed is:

1. A method for producing a rubber composition comprising a diene rubber, one or more resins, and a styrene based thermoplastic elastomer,
the resin(s) being one or more out of nonaromatic terpene resins and aliphatic petroleum resins, and
the method comprising the step of mixing the resin(s) with the styrene based thermoplastic elastomer to produce a kneaded product, and
the step of mixing the resultant kneaded product with the diene rubber.

2. The method for producing a rubber composition according to claim 1, wherein the styrene based thermoplastic elastomer has a glass transition temperature of −70 to 0° C.
